(19) United States
(12) Patent Application Publication
(10) Pub. No.: US 2011/0016807 A1
(43) Pub. Date: Jan. 27, 2011

(54) MULTI-LAYERED WOOD DOOR COMPRISING A POCKET FOR A GLASS SHEET

(76) Inventor: Andrea Amato, Comiziano (IT)

Correspondence Address: YOUNG & THOMPSON, 209 Madison Street, Suite 500, Alexandria, VA, 22314, US

(21) Appl. No.: 12/866,299

(22) PCT Filed: Feb. 5, 2009
(86) PCT No.: PCT/IT09/00033

§ 371 Date: Oct. 7, 2010

(30) Foreign Application Priority Data
Feb. 5, 2008 (IT) RM2008A000061

(51) Int. Cl. E06B 3/78; E06B 3/66

(52) U.S. Cl. 52/204.5; 52/456

(57) ABSTRACT

Wood door (10) with at least a sheet (14) slipped in, made of two panels on which a light window is realised the two panels being coupled with one another with the interposition of perimetric strips (17, 19) on three sides, defining with their thickness an interspace inside which the sheet (14) is slipped in.

The present invention relates to a wood door with at least a sheet slipped in.

More particularly, the invention relates to a wood interior door with at least a sheet of transparent or semitransparent material, preferably glass or plexiglas, slipped in, and has the aim of realising a door having unequalled aesthetical features, obtained applying wood panels upon said at least a slipped in sheet and attaining an innovative and unexpected impression, the door looking like an homogeneous body passed through by the light according to many different shapes.

Traditionally, interior doors with passing through openings (also called light windows) padded with one or more sheets generally made of glass, are realised by inserting the sheet of glass, having size and shape substantially identical to those of the light window provided on the door, on the same light window and subsequently fixing the sheet by means of strips, placed all around the contour of the sheet, fixed in turn to the structure of the door.

This kind of door has the problem that, as a consequence of the weight of the sheet of glass, the strips, unless they are carefully fixed by a suitable and correctly placed number of nails, applied by suitably instructed manpower, are often insufficient to assure the fixing of the sheet, in particular in case the sheet has considerable size and dimensions and important weight and is stressed in consequence of shoves or very sudden movements.

According to an alternative embodiment of this kind of doors, also in order to assure a better fixing of the sheet of glass, it is provided for the slipping in of the sheet in the structure of the door.

Generally, the method of slipping in the sheet of glass is used in case of doors made of assembled contour components. In practice, contour components, realised so to comprise suitable groovings, are assembled on three sides of the light window that will house the sheet of glass, for example by assembling the bottom rail and two stiles of the structure of the door; then the sheet of glass is obliged to slide in the grooves realised on the stiles and subsequently also the last contour component, the top rail, is assembled with the others and, accordingly, with the sheet of glass.

Aesthetically, this kind of door shows cuts and discontinuities in the grain, since the assembly of different components implies the presence of different lines of contact.

In order to overcome also this kind of limitation, doors are realised which have a face made of a sole piece, thus aesthetically homogeneous, with sheet of glass slipped in.

According to the prior art, the method of slipping in provides for the use of a frame structure prepared with grooves to be passed by the sheet of glass or other material, on which two coating panels are adhered, respectively on the two faces, the coating panels can have different thickness, normally from 4-6 mm of a honeycomb sandwich door to 10-12 mm of a solid wood door. The two coating panels are kept separate by the intermediate presence of the frame structure, and the hollow space between the coating panels and the sheet of glass is filled by means of suitable structures, reproducing the shape of the light window. In general, the method provides for the insertion of only one sheet of glass with only one light window.

In case it is desirable to realise a door with a light window divided in a plurality of sectors by means of crossing elements, then the frame structure with the already said grooves is added with crossing wood strips, at intermediate heights of the light window, already split or prepared to be divided by a blade during the emptying, in the first case by interposing, while gluing, a spacer in order to compensate the emptying for the passage of the glass, in order to assure a good cohesion between the front panel and the transversal elements of the frame structure interested by the passage of the glass.

From the use of this technique necessarily derives some aesthetical, technical and productive problems greatly limiting the possibility of using it, its aesthetical and productive suitability. In fact, the structure prepared for the passage of the glass and for filling up the room between the front panels and the sheet of glass is composed of a plurality of assembled pieces: after gluing with the two panels constituting the faces of the door panel, it is possible to see the line of connection between the different elements and between the same elements and the panels. Thus, it is possible to see cuts and changes in the grain of the wood with respect to the homogeneity of the glued surface.

Further, using the structure prepared for the slipping in and for filling up the room between the front panels and the sheet of glass, the problem is that, in order to correctly adhere the internal structure with the panels, some spacers must be interposed at the same height of the transversal parts possibly present, with the function of filling up the gaps that will be subsequently occupied by the sheet of glass, thus experiencing important problems during the production step, caused by the complexity of the making and by the possibility of strains that, in case of moving closer together the parts, could impair the passage of the sheet, or, in case of moving the parts away from each other, could leave gaps between the door and the sheet after assembling.

This implies the necessity of realising transversal elements having small dimensions, and further having a squared shape, in order to make the making of the structure easier and to have a greater possibility of obtaining a good gluing and a good stability of the panel, and consequently it turns out to be difficult to cover with the sheet of glass big surfaces, and to extend the desired effect to portions and dimensions close to those of the door.

Further, another important problem is the need of realising a specific structure for filling up the room between the front panels and the sheet of glass for each model of windowed door to be realised, thus generating remarkable inconveniences in making, giving to the product a more craftman like aspect, reason why generally no or very few producers manufacture doors having a glass sheet slipped in, and in case only for very few models.

In this context is proposed the solution according to the present invention, with the aim of providing for a door with at least a sheet slipped in an interspace, obtained by coupling together, by means of perimetric strips, two solid panels, assembled or emptied, said sheet having the possibility to be almost as big as the door and interesting a material that is homogeneous on the whole thickness, with the possibility of creating any light window in the panel in order to create shapes of a different kind. Further, the present invention has the aim of providing for a door with a sheet slipped in on which it is possible to apply panels that, in case the sheet is made with a transparent or partially transparent material, allow for the creation of lighting effects with precisely defined shapes, defined by the portion of sheet remaining in sight between the profile of the light window and that of the panels applied on the sheet, generally reproducing the same shape, with reduced dimensions, of the light window.

The primary aim of the present invention is therefore that of proposing a door with a sheet slipped in allowing for a vast range of possibilities of variation of shapes of the portions of the sheet left in sight, without negatively affect the costs for manufacture.

Further, an aim of the invention is to allow for the sheet slipped in a door to place in the middle of the door and undertaking structural functions contributing to the stability of the door and allowing for the application on the same sheet of panels, even heavy ones.

Another aim of the invention is further that of realising a door completely different from traditional ones, giving the impression of a single and homogeneous body, passed by a sheet of glass or different material subsequently assembled, on which a panel can be subsequently applied thus obtaining an aesthetically and particularly new aspect.

These and other results are achieved according to the present invention by proposing a new process of slipping in allowing for the maximum homogeneity and possibility of use for the manufacturing of many various models and designs, overcoming the remarkable problems and drawbacks of the solutions according to the prior art.

An aim of the present invention is therefore that of manufacturing a door with a sheet slipped in and a process for its manufacturing allowing or overcoming the limits of the solutions according to the prior art and to obtain the results described previously.

It is therefore a specific object of the present invention a wood door, in particular an interior door, with at least a sheet slipped in, made of two panels on which is realised a light window and coupled with one another with the interposition of perimetric strips on three sides, defining with their thickness an interspace inside which said sheet is slipped in.

Preferably, according to the invention, said panels are emptied backwards and said perimetric strips, being thicker than the sheet, have the portion in excess with respect to the thickness placed in the obtained emptying and are joined together so to constitute a real structure. In this way, after gluing the panels on the structure a stiffening of the door is obtained, the door resulting more stable.

Always according to the invention, said strips are made of wood or any other structurally stiff material.

Preferably, according to the invention, said sheet is made of transparent or semitransparent material.

Still according to the invention, said sheet can be made of polymethilmethacrylate or glass.

Further, always according to the invention, said sheet can be made of double glazing with lighting sources inside.

Further, always according to the invention, on said sheet, respectively on opposed faces of said sheet, panels can be applied, preferably made of wood having the same finishing of the external structure of the door.

It is immediately evident the efficacy of the door and the process of the present invention, allowing the sheet slipped in for placing in the middle of the door and undertaking structural functions contributing to the stability of the door and allowing for the application of panels on the same sheet, even heavy panels. The higher structural stability is particularly important, since the door is a body that must necessarily remain stable and undergoes continuous stresses. Further, the application of a panel on the sheet, in general having the same finishing of the external structure, and preferably on the sheet in transparent or semitransparent material, defines a shape that is desired to be perceived that seems to cross the door, thus allowing to obtain an aesthetically new and particularly appreciable product.

The application of a panel on a sheet of glass, previously slipped in the door according to the present invention, the panel reproducing the same material of the front of the same door, allow to give to the sheet of glass a function going beyond that of decorative element as traditionally meant, as a consequence of its shape, colour and any other aspect inside it.

An advantage that only the present invention allows to obtain is that of making possible to generate lighting effects with many different shapes, not only solid shapes but also simple contours, with the result that the panels applied on the sheet look like suspended in the light or different material, passing the door. This impression is much more strong if obtained by means of glasses that, besides being beautiful and refined are also safe and resistant, so to become an integral part of the structure of the door and to decorate not with their intrinsecal beauty, but with the shape defined by the applied panel, looking like a lighting beam crossing the door according to solid shapes or contours.

This is possible tank to a system of slipping in the sheet of glass allowing for living uniformity and homogeneity to the door in each part, so it looks like crossed by the light, preventing from the presence of glass-stop frames, and at the same time allowing for realising a great variety of models in a simple and cheap way.

In the following the advantages with respect to the doors according to the prior art are summoned.

From an essentially technical point of view, the sheet is inserted in the interspace between the two panels constituting the faces of the door, giving to the door a uniform and compact aspect. The sheet thus undertakes a structural function, also because it can represent a surface that is wide almost as the frame structure of the door and is fixed to the wood part so to become a sole body with the other parts of the door. Further, the making of the door is made easier because it is prevented the need of using a structure, with a shape similar to that of the light window, suitably prepared inside the door. Further, thanks to the solution of the present invention possibly present intermediate transversal portions of the front of the door can be wider, and having non-squared shapes, further assuring the stability and non-deformability of the door.

From an aesthetical point of view, the possibility of realising the door without prepared internal structures, allows to prevent inhomogeneityin the panel, since no gluing point is provided on the face in sight. The aesthetical result is remarkable, in consideration of the uniformity and homogeneity of the door itself. Further, it is easier to realize light windows having non squared shapes, with a further innovative effect with regard to the prior art. Moreover, once a sheet is slipped in the structure, a panel can be applied on it, in particular, in case of sheets of glass or any other transparent or semitransparent material thus defining a surreal lighting effect, two to the fact that the panel looks like it is suspended in air, or even better in light.

Finally, from a productive point of view, the panels of the door can be windowed in any way, since the sheet to be slipped in has a shape being a function of the disposition of the perimetric strips and not being necessary to interpose between the panels a structure suitably prepared for the specific model of light window, and not realising as many glass-stop frames for each light windows to be realised. This allows for storing already assembled doors and better managing storehouses, materials and productive cycles (a door being prepared for any light window), and the doors can be characterised by wide surfaces positioned transversally with respect to the glass to be slipped in, without any problem of strains or possible complications for the manufacturing of structures having an irregular shape; therefore, this allows for the manufacturing of many various models without any problem, with the consequently derived productive and commercial advantages.

Moreover, the possible use of the technique of emptying the panels allows for obtaining further functional advantages, since the door becomes lighter, and further also structural advantages, since the structure defined on three sides of the emptied area increases the stiffness and the static strength of the door. In case of solid wood doors, this could even allow for limiting strains in the wood (limiting the thickness) and giving a guarantee of higher stability, both of the single components and of the door as a whole.

The present invention will be described for illustrative non limitative purposes, according to its preferred embodiments, with reference in particular to the figures of the enclosed drawings, wherein:

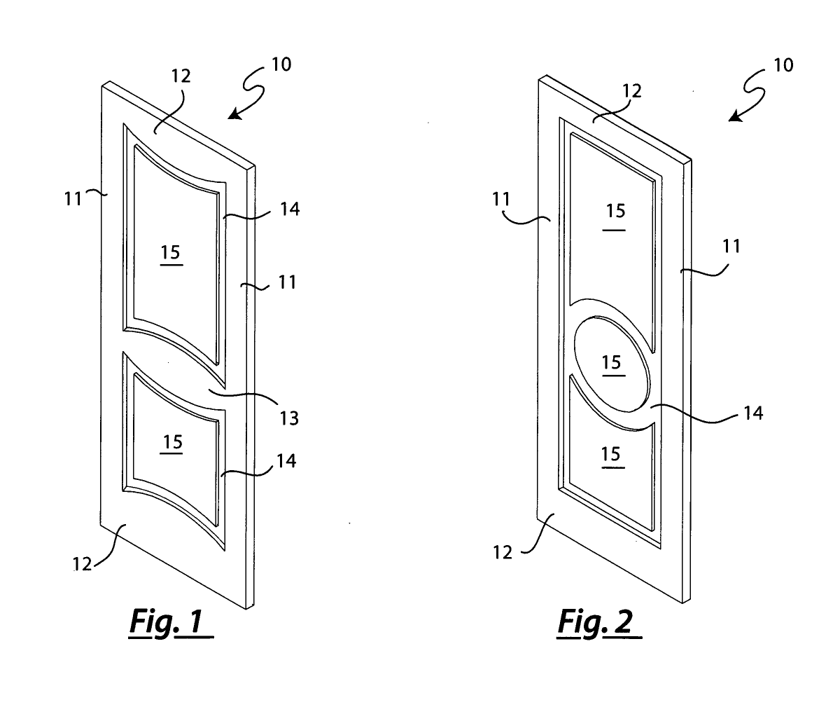

FIG. 1 shows a perspective view of a door according to a first embodiment of the present invention,

FIG. 2 shows a perspective view of a door according to a second embodiment of the present invention,

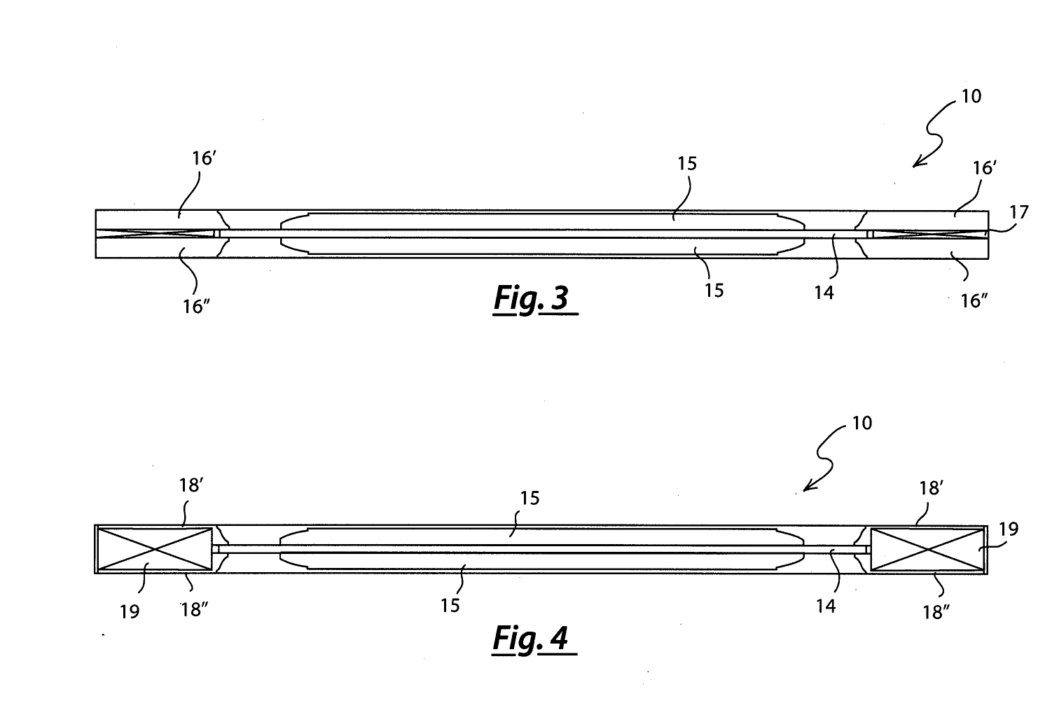

FIG. 3 shows a sectional transversal view of a door according to a third embodiment of the present invention,

FIG. 4 shows a sectional transversal view of a door according to a fourth embodiment of the present invention,

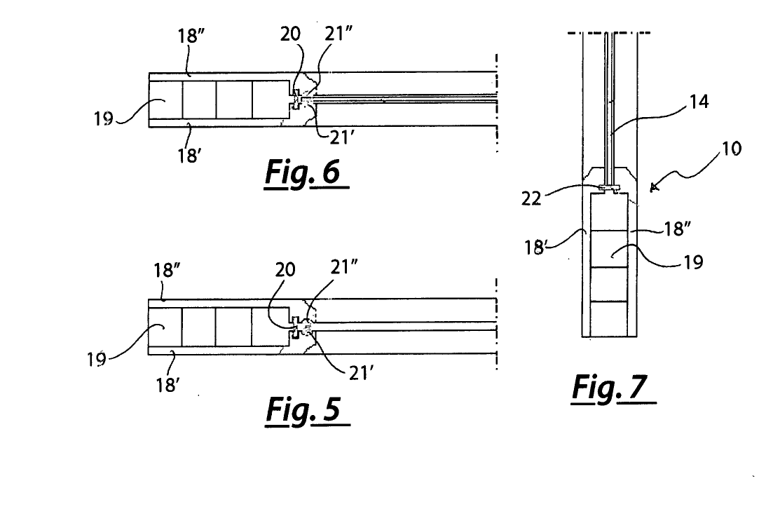

FIG. 5 shows a sectional transversal view of a door according to a fifth embodiment of the present invention, without the sheet,

FIG. 6 shows a sectional transversal view of the door of FIG. 5, with the glass, and

FIG. 7 shows a sectional transversal view of the lower portion of the door of FIG. 5.

Making reference to the figures, the door as a whole, regardless its different embodiments, is always referred with the numeral 10.

The door 10 shown with reference to FIG. 1, has a body with two longitudinal portions 11, two transversal portions 12 and one intermediate transversal portion 13, defining two light windows, in particular one upper light window and a lower light window, through which it is possible to see corresponding portions of a sheet 14 slipped in according to the system of the present invention. Panels 15 are applied on each portion in sight of the sheet 14, having the same exterior aspect (colour, grain) of the rest of the door. The portions of the sheet 14 remaining in sight between the panels 15 and the borders of the light windows as defined by said two longitudinal portions 11, two transversal portions 12 and one intermediate transversal portion 13, draw a contour the shape of which can vary as much as desired and through which, in case of a sheet 14 in transparent or semitransparent material, the light is free to pass, producing a particular aesthetical effect.

With reference to the embodiment of the door 10 shown in FIG. 2, it presents a single light window through which the sheet 14 is visible, on which three panels 15 are applied, having different shapes in order to obtain a different effect through the portion of sheet 14 left free.

With reference to FIG. 3, the door 10 is comprised of two independent faces 16′, 16″ fixed to each another by means of perimetric strips 17 allowing for obtaining an interspace in which a glass sheet 14 is slipped in. The innovative system of slipping in allows for the sheet 14 to place in the middle of the door. Further, two panels 15 are applied on the sheet 14, respectively on two opposed sides of the sheet 14.

On the contrary, the door 10 shown in FIG. 4 was obtained by coupling two panels 18′, 18″ engraved backwards so to define after coupling a perimetric space for the positioning of thicker strips 19, defining an interspace always having the necessary thickness for the sheet 14. In this case also panels 15 are applied on the sheet 14.

In both cases, the sheet 14 does not reproduce the shape of the light windows but is almost as big as the whole door 10, with the consequent possibility of producing any light window in order to create different solid shapes or contours, to show a beautiful glass or to reduce the effect of a door perforated according to any shape, also thinks to the use of the applied panels 15.

Further, FIGS. 5-7 show a further embodiment with further manufacturing features making the manufacture of a door according to the present invention easier. In particular, on a door 10 as that shown in FIG. 4, obtained by coupling two panels 18′, 18″ engraved backwards so to define after coupling a perimetric space for the positioning of thicker strips 19, such features comprise additional grooves realised perimetrically on the back of the panels 18′, 18″ before gluing them. In such grooves (milled) a spacing strip 20 and two gaskets 21′ and 21″ are positioned. Moreover, optionally, grooves can also be realised on the sheet 14, in a position corresponding to that of the grooves on the back of the panels 18′, 18″ for the gaskets 21′, 21″, to complete the housing of the gaskets 21′, 21″.

The spacing strip 20 has the important task of coupling with the highest accuracy the panels 18′, 18″, representing for them a guide or a bond preventing them from sliding or skidding during gluing. The accuracy of the coupling allows for emptying the panels 18′, 18″ and engraving them also on the front face (beside the back) before cooling them, with remarkable improvements in the stability of the door and the quality of the varnishing. In fact, in such a way it is possible to sandpaper and varnishing the panel also from the back, before gluing it to the other and proceeding with the other manufacturing steps and the final varnishing. Such spacing strip 20 also contributes in preventing the glue from coming in touch with the portion that will be occupied by the glass, hindering its passage.

The gaskets 21′, 21″ importantissime are also very important because by gripping they increase friction on the sheet 14 and maintain it motionless; at the same time allowing the sheet 14 to undergo small dimensional variations due to sudden changes of temperature. In the lower portion of the door 10, shown in particular with reference to FIG. 7, the strip is replaced by a rigid gasket 22, also replacing the gaskets 21′, 21″, running all along the length of the glass slipped in.

The solution shown with reference to FIGS. 5-7, beside on a door 10 like that shown in FIG. 4, can also be applied on a door of the kind shown with reference to the remaining FIGS. 1-3, without any particular precautions with respect to what was already shown.

The invention can be identified in a product innovating the traditional manufacturing of the panel wood door. It is performed through a method of slipping in providing for the insertion of a sheet, in particular a sheet of glass, inside the door, and not from one side of the same. In such way a new creation is achieved, better and having a remarkable aesthetical impact and great productive suitability.

The element crossing the two panels, coupled to each other realizza reso to realise a single “perforated” body, becomes an integral part of the structure of the door, being fixed to the panel door and interesting a surface that can be almost the same as that of the panel door itself.

Further, the application of other panels on the sheet, in particular on the sheet of glass, is a new technique, necessary to produce a new aesthetical and formal identity of door and that in turn make it necessary to define a suitable operational technique for obtaining that result. The proposed operational technique is a process that, in any other situation and with any other purpose would result to be uneconomic and unproductive, because it is too laborious. In fact, it provides for dith er independent manufacturing of two homogeneous or composite panels, subsequently glued interposing between them some perimetric strips made of wood or other structurally rigid material having the same thickness of the sheet to be slipped in, or after engraving the back side to insert perimetric strips having a thickness greater than that of the sheet to be slipped in, so to realize in the middle an interspace having the necessary thickness to house the sheet. This naturally require the use of materials in excess and lavorazioni manufacturing from which the non suitability derives, except for the need to give to the two faces of the door an absolute homogeneity, and making real the possibility of realising a fast and suitable system of slipping in in a moment in which the manufacturing of door is starting and it is necessary to manufacture many different models.

Such a system further allows for living any shape to the windowed portion, with the only exclusion of the area closer to the perimetric structure.

In fact, the sheet lippe in between the two panels could have always dimensione the same size and does not require to provide decorations for aesthetical purposes, since the panel to be applied on the sheet can have any shape and therefore the room and the shape left between the panel and the windowed portion of the door can define what is desired to be evidenced with the material interposed between the two panels.

The present invention was described for illustrative, non limitative purposes, according to preferred embodiments thereof, but it has to be understood that any variation and/or modification can be made by the persons skilled in the art without escaping the pertinent scope of protection, as defined by the enclosed claims.

1. Wood door (10) with at least a sheet (14) slipped in, characterised in that it is made of two panels (16′, 16″, 18′, 18″) on which a light window is realised, the panels being coupled with one another with the interposition of perimetric strips (17, 19) on three sides, defining with their thickness an interspace inside which said sheet (14) is slipped in.

2. Door (10) according to claim 1, characterised in that said panels (18′, 18″) are emptied backwards and said perimetric strips (19), being thicker than the sheet (14), have the portion in excess with respect to the thickness placed in the obtained emptying and are joined together so to constitute a real structure.

3. Door (10) according to claim 1, characterised in that said strips (17, 19) are made of wood or any other structurally stiff material.

4. Door (10) according to claim 1, characterised in that said sheet (14) is made of transparent or semitransparent material.

5. Door (10) according to claim 1, characterised in that said sheet (14) is made of polymethilmethacrylate or glass.

6. Door (10) according to claim 1, characterised in that said sheet (14) is made of double glazing with lighting sources inside.

7. Door (10) according to claim 1, characterised in that panels (15) are applied on said sheet (14), respectively on two opposite faces of said sheet (14).

8. Door (10) according to claim 7, characterised in that said panels (15) are made of wood having the same finishing of the external structure of the door.

9. Door (10) according to claim 1, characterised in that grooves are provided perimetrically on the back of said panels (18′, 18″) for the housing of a spacing strip (20).

10. Door (10) according to claim 1, characterised in that grooves are provided perimetrically on the back of said panels (18′, 18″) for the housing of a system of gaskets (21′, 21″, 22).

11. Door (10) according to claim 2, characterised in that said strips (17, 19) are made of wood or any other structurally stiff material.
